(19) United States
(12) Patent Application Publication
(10) Pub. No.: US 2026/0097639 A1
(43) Pub. Date: Apr. 9, 2026

(54) LOW CENTER OF GRAVITY RECREATIONAL VEHICLE WITH RANGE EXTENDER

(71) Applicant: Thor Tech, Inc., Elkhart, IN (US)

(72) Inventors: Dustin Feller, Wolcottville, IN (US); Simon Wespel, Waldsee (DE); Thomas Ramsay, Elkhart, IN (US); Mitchell Johnson, Elkhart, IN (US); James Kane, Detroit, MI (US)

(73) Assignee: Thor Tech, Inc., Elkhart, IN (US)

(21) Appl. No.: 19/334,087

(22) Filed: Sep. 19, 2025

Related U.S. Application Data
(60) Provisional application No. 63/697,188, filed on Sep. 20, 2024.
(60) Provisional application No. 63/697,870, filed on Sep. 23, 2024.

(51) Int. Cl. B60K 6/46; B60J 1/00; B60K 6/24; B60K 6/26; B60K 6/28; B60P 3/32; B62D 21/18; B62D 25/06; B62D 27/02

(52) U.S. Cl. CPC B60K 6/46; B60K 6/24; B60K 6/26; B60K 6/28; B60P 3/32; B62D 21/18; B62D 25/06; B62D 27/026; B60J 1/00; B60Y 2200/40; B60Y 2200/92; B60Y 2400/112

(57) ABSTRACT

A recreational vehicle (RV) may include may include a chassis including longitudinal frame rails, an axle, and an RV body. The RV body may include an RV roof. The RV roof may include foam core units, a composite shell, and a biaxial glass perimeter along a perimeter of the RV roof. The RV may further include an RV battery that may be positioned between the longitudinal frame rails, forward of a center of mass of the RV, and below the RV floor of the RV body. The RV may also include a range extender that may be positioned between the longitudinal frame rails, rearward of the center of mass of the RV, and below the RV floor of the RV body. The RV may further include an electric motor that may be positioned rearward of the center of mass of the RV.

### CROSS-REFERENCE TO RELATED APPLICATIONS

This application claims the benefit of U.S. Provisional Application Ser. No. 63/697,188, filed Sep. 20, 2024 and U.S. Provisional Application Ser. No. 63/697,870, filed Sep. 23, 2024.

### BACKGROUND

The present disclosure relates to recreational vehicles. Specifically, the present disclosure relates to recreation vehicle roofs and the utilization of range extenders within recreational vehicles.

### BRIEF SUMMARY

According to the subject matter of the present disclosure, a recreational vehicle (RV) is provided. Contemplated RVs include an RV body including an RV roof with a plurality of foam core units and improved aerodynamic construction. Moreover, contemplated RVs include an RV battery, range extender, and electric motor. Positioning of such components provides a low and central center of mass, such as to improve handling of the RV.

Traditionally, RVs have a high center of mass due to engine components and RV accessories being mounted above a frame of the RV. Moreover, RVs often suffer from poor fuel economy, due to heavy weight and poor aerodynamic constructions. In embodiments illustrated herein, the RV includes an aerodynamic foam roof. Moreover, the RV includes a battery and range extender mounted below the frame of the RV. Thus, the embodiments described herein provide for an RV with increased aerodynamics and a low center of mass that improves handling.

In accordance with one embodiment of the present disclosure, a recreational vehicle (RV) may include a chassis including longitudinal frame rails, an axle, and an RV body enclosing a living area supported by the chassis. The RV body may include an exterior wall, an RV floor, and an RV roof. The RV roof may include a plurality of foam core units, a composite shell surrounding a majority of the plurality of foam core units, and a biaxial glass perimeter along a perimeter of the RV roof. The RV may further include an RV battery coupled to the chassis and the RV battery may be positioned between the longitudinal frame rails, forward of a center of mass of the RV, and below the RV floor of the RV body. The RV may also include a range extender. The range extender may include an engine, an alternator electrically coupled to the RV battery, a fuel system, a cooling system, and a battery recharge controller. The range extender may be coupled to the chassis and may be positioned between the longitudinal frame rails, rearward of the center of mass of the RV, and below the RV floor of the RV body. The RV may further include an electric motor electrically coupled to the RV battery. The electric motor may provide motive support to the axle of the RV and the electric motor may be positioned rearward of the center of mass of the RV.

In accordance with another embodiment of the present disclosure, an RV may include a chassis including longitudinal frame rails, an axle, and an RV body enclosing a living area supported by the chassis. The RV body may include an exterior wall, an RV floor, and an RV roof. The RV roof may include a plurality of foam core units, a composite shell surrounding a majority of the plurality of foam core units, and a biaxial glass perimeter along a perimeter of the RV roof. The RV may also include an RV battery coupled to the chassis and the RV battery may be positioned between the longitudinal frame rails and below the RV floor of the RV body. The RV may also include a range extender. The range extender may include an engine, an alternator electrically coupled to the RV battery, a fuel system, a cooling system, and a battery recharge controller. The range extender may be coupled to the chassis and may be positioned between the longitudinal frame rails and below the RV floor of the RV body. The range extender and RV battery may positioned on opposite longitudinal sides of a center of mass of the RV. The RV may further include an electric motor electrically coupled to the RV battery. The electric motor may provide motive support to the axle of the RV.

Although the concepts of the present disclosure are described herein with primary reference to RVs, it is contemplated that the concepts will enjoy applicability to any vehicle. For example, and not by way of limitation, it is contemplated that the concepts of the present disclosure will enjoy applicability to cars, trucks, tractor-trailers, or any other suitable vehicle.

### BRIEF DESCRIPTION OF THE SEVERAL VIEWS OF THE DRAWINGS

FIG. 1 depicts an example RV, according to one embodiment of the present disclosure;

FIG. 2 depicts an example top-view of an RV, according to one embodiment of the present disclosure;

FIG. 3A depicts an example exploded view of units of an RV roof, according to one embodiment of the present disclosure;

FIG. 3B depicts an example RV roof, according to one embodiment of the present disclosure;

FIG. 3C depicts an example front view of an RV roof, according to one embodiment of the present disclosure;

FIG. 3D depicts an example exploded view of an RV roof, according to one embodiment of the present disclosure;

FIG. 4A depicts an example front view of an RV roof and sidewalls, according to one embodiment of the present disclosure;

FIG. 4B depicts an example side view of an RV roof and sidewalls, according to one embodiment of the present disclosure;

FIG. 5 depicts an example engine bracket, according to one embodiment of the present disclosure;

FIG. 6 depicts an example bottom fuel tank bracket, according to one embodiment of the present disclosure;

FIG. 7 depicts an example top fuel tank bracket, according to one embodiment of the present disclosure;

FIG. 8 depicts an example radiator bracket, according to one embodiment of the present disclosure; and

FIG. 9 depicts an example bottom view of the RV, according to one embodiment of the present disclosure.

### DETAILED DESCRIPTION

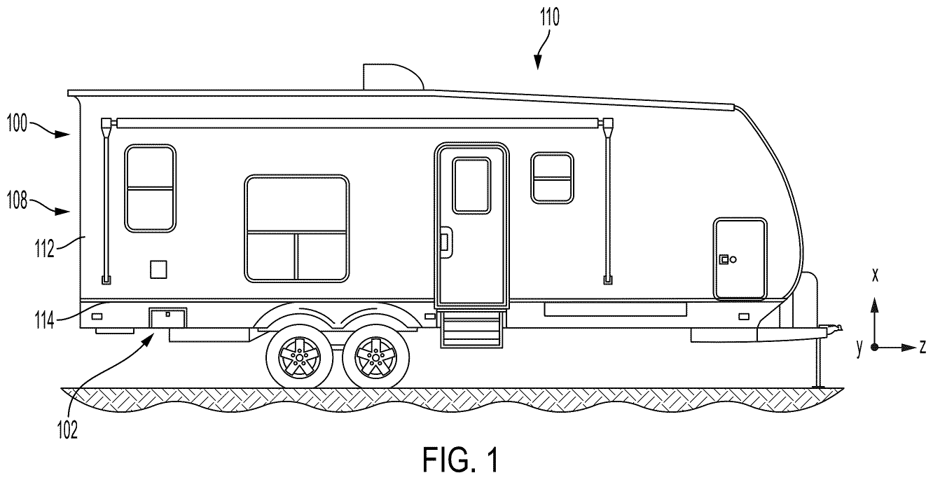

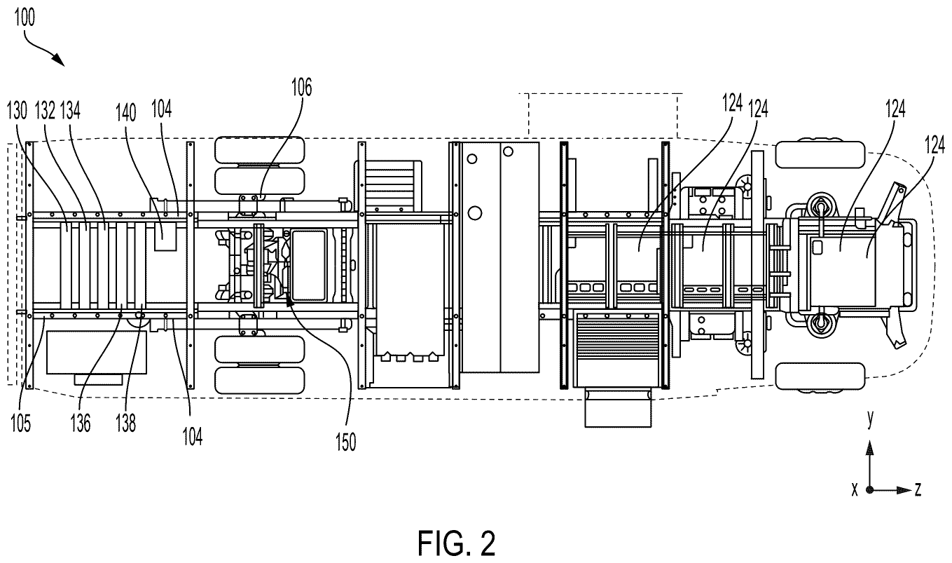

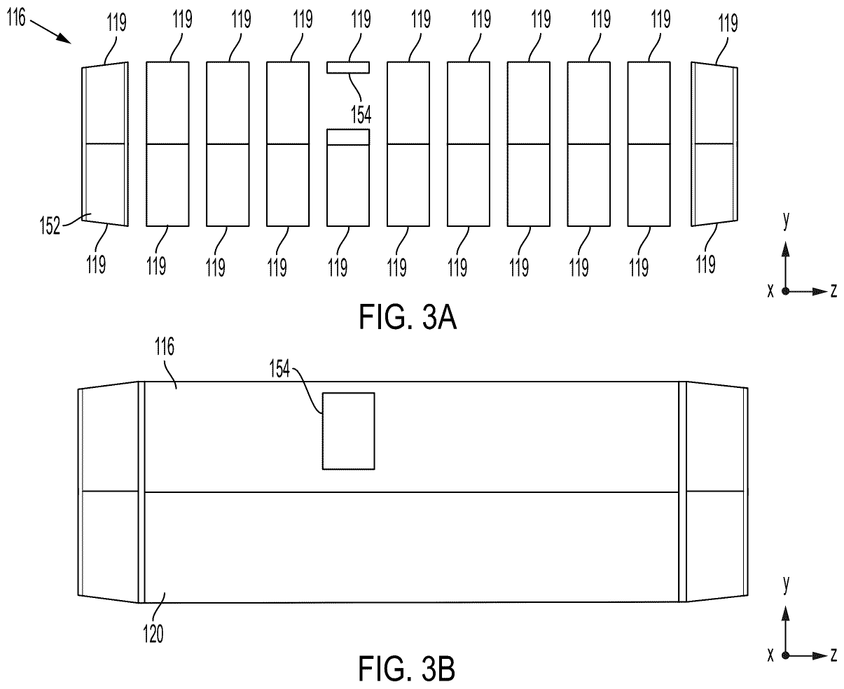

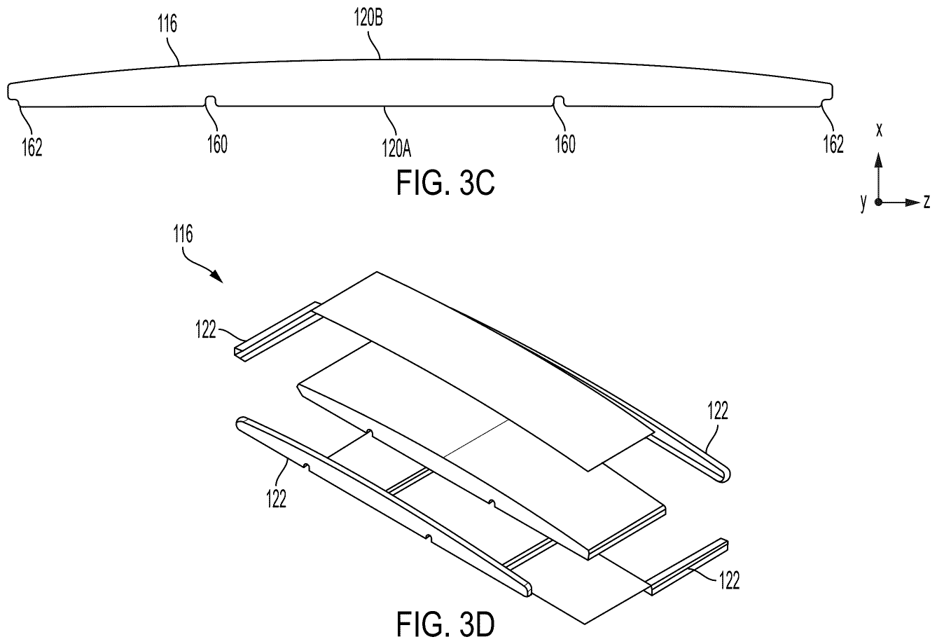

FIG. 1 depicts an RV 100. The RV includes a chassis 102 including longitudinal frame rails 104 and an axle 106 (as depicted in FIG. 2). The RV 100 further includes an RV body 108 enclosing a living area 110 supported by the chassis 102. The RV body 108 includes an exterior wall 112, an RV floor 114, and an RV roof 116. The RV roof 116 includes a plurality of foam core units 118, a composite shell 120 surrounding a majority of the plurality of foam core units 118, and a biaxial glass perimeter 122 along a perimeter of the RV roof 116 (as depicted in FIG. 3D). The RV 100 further includes an RV battery 124 coupled to the chassis 102 and positioned between the longitudinal frame rails 104, forward of a center of mass of the RV 100, and below the RV floor 114 of the RV body 108.

The RV 100 further includes a range extender 130 including an engine 132, an alternator 134 electrically coupled to the RV battery 124, a fuel system 136, a cooling system 138, and a battery recharge controller 140. The range extender 130 is coupled to the chassis 102 and positioned between the longitudinal frame rails 104, rearward of the center of mass of the RV 100, and below the RV floor 114 of the RV body 108. The RV 100 also includes an electric motor 150 electrically coupled to the RV battery 124. The electric motor 150 provides motive support to the axle 106 of the RV 100. Moreover, the electric motor 150 is positioned rearward of the center of mass of the RV 100.

Referring now to FIG. 2, a top view of the chassis 102 of the RV 100 is depicted. Specifically, the chassis 102 may include longitudinal frame rails 104. The longitudinal frame rails 104 run from near a front 200 of the RV 100 to a rear 202 of the RV 100. The longitudinal frame rails 104 may be I-beams, c-shaped, square/rectangular in cross-section, or any other suitable shape.

The longitudinal frame rails 104 may support many components of the RV 100, such as the axle 106, the floor 114, the RV battery 124, the range extender 130, or the electric motor 150 (as described further below). As such, the longitudinal frame rails 104 may include connection points for each of the components mounted to the longitudinal frame rails 104. The connection points may include holes along the longitudinal frame rails 104 in corresponding holes of mounting equipment of the components of the RV 100 may be attached through the use of pins, screws, bolts, or any other suitable mounting equipment.

The axle 104 of the RV may be a rear-axle, that the axle is positioned at the rear wheels of the RV 100. The axle 104 may also be a front-axle, such that the axle is positioned at the front wheels of the RV 100. Although the axle 104 is depicted as a rear-axle in FIG. 2, it should be understood that embodiments contemplated herein may include a rear-axle, front-axle, or both a rear and front-axle.

The RV body 108 encloses the living area 110 supported by the chassis 102. The living area 110 may include a living space for occupants and the cockpit. The RV body 108 includes the exterior wall 112, the RV floor 114, and the RV roof 116. The RV body 108 may be made of lightweight materials to lower the center of mass of the RV 100 and, thus, improve handling of the RV 100. The use of lightweight materials also improves fuel efficiency of the RV 100. Construction of the RV roof 116 and the joinery of the RV roof 116 to the exterior walls 112 are described in greater detail below.

Referring now to FIGS. 3A-3D, the RV roof 116 is depicted. Specifically, FIG. 3A depicts a top exploded-view of the plurality of foam core units 118 of the RV roof 116. The plurality of foam core units 118 may include a foam core 119 and fiberglass 121 surrounding the foam core 119. In embodiments, the foam core 119 may be a single foam core that spans the entirety of the RV roof 116. It should be understood that the foam core 119 may be any number of individual foam core units, such as in each of the plurality of foam core units 118. The foam core 119 may be polyurethane foam, open-cell foam, closed-cell foam, or any other suitable foam.

In embodiments, a fiberglass reinforcement layer 152 may be coupled to the exterior the foam core 119. There may be a fiberglass reinforcement layer 152 for each of the plurality of foam core units 118. The fiberglass reinforcement layer 152 may be coupled to the foam core 119 through the use of adhesives or any other suitable means of coupling the fiberglass reinforcement layer 152 to the foam core 119. The fiberglass reinforcement layer 152 may further strengthen the RV roof 116, while maintaining a lightweight construction of the RV 100.

The fiberglass reinforcement layer 152 and the foam core 119 may include a cutout 154. The cutout 154 may be positioned in any number of the plurality of foam core units 118. The cutout 154 may be positioned at a location of a skylight on the RV roof 116. The cutout 154 may also be a location of an air-conditioning unit mounted to the RV roof 116, storage compartments mounted to the RV roof 116, or any other accessory that is mounted to/stored on the RV roof 116.

Referring now to FIG. 3D, an exploded view of the plurality of foam core units 118, the composite shell 120 surrounding the foam core units 118, and the biaxial glass perimeter along the perimeter of the RV roof 116 is depicted. The composite shell 120 may surround a majority of the foam core units 118. The composite shell 120 may be the outermost layer of the RV roof 116. Thus, the composite shell 120 may be weather resistant, such as to prevent leaks in the RV roof 116. The composite shell 120 may include an interior facing shell 120A and an exterior facing shell 120B. In embodiments, the interior facing shell 120A may be made of a different material compared to that of the exterior facing shell 120B, since the exterior facing shell 120B is subject to weather conditions and the interior facing shell 120A faces the living space of the RV 100. The composite shell may be joined to the foam core units 118 through the use of adhesives, bolts, screws, or any other suitable means of coupling. The composite shell 120 may be made of fiberglass, glass-reinforced plastic, carbon fiber, thermoplastic polyolefin, urethane, or a combination thereof.

Referring still to FIG. 3D, the biaxial glass perimeter 122 may surround the perimeter of the RV roof 116. The biaxial glass 122 may join the interior facing shell 120A and exterior facing shell 120B of the composite shell 120 and the foam core units 118 together. Moreover, the biaxial glass 122 provides strength to the RV roof 116, such that the RV roof 116 is held together when subject to stresses. Moreover, the biaxial glass 122 protects the perimeter of the RV roof 116 from impacts/rubbing on debris.

Referring now to FIG. 3C, side-view of the RV roof 116 is depicted. The RV roof 116 may include accessory channels 160 positioned on the interior facing shell 120A of the composite shell 120. The foam core units 118 may also include notches to accommodate/make-up the accessory channels 160. Various accessories or components may be mounted to the accessory channels 160 of the RV roof 100. For example, wiring, lighting, mounting surfaces, or other components may be secured within the accessory channels 160. Although two accessory channels 160 are depicted in FIG. 3C as running along an axial length of the RV roof 116, it should be understood that any number of accessory channels 160 may be included in the RV roof 100. Moreover, the accessory channels 160 may run along the longitudinal length or axial length of the RV roof 100. The accessory channels 160 may hide wiring or other unaesthetic components from view within the living space of the RV 100. Moreover, when lighting is provided within the accessory channels 160, the accessory channels 160 allow for the lighting to sit flush with the ceiling of the living space.

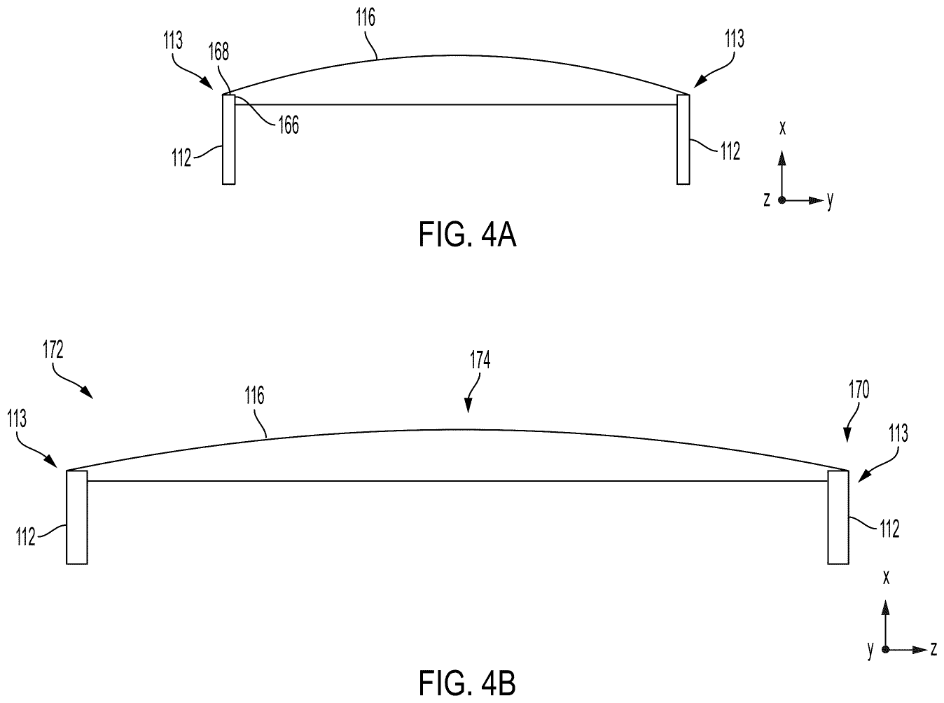

Referring now to FIG. 4, the RV roof 116 may further include a securement channel 162 on the interior facing side 120A of the RV roof 116. Moreover, the exterior wall 112 may include a top edge portion 113. The top edge portion 113 of the exterior wall 112 may fit within the securement channel 162 of the RV roof 116. The top edge portion 113 of the exterior wall 112 may be secured within the securement channel 162 of the RV roof 100 through adhesives, screws, bolts, or any other suitable fastener. FIG. 4A depicts a front-view of the RV roof 116, while FIG. 4B depicts a side-view of the RV roof 116. As such, the securement channels 162 may be included to join the RV roof 116 with any of the exterior walls 112 of the RV 100 (e.g., sidewalls and front/rear walls of the RV 100).

The RV roof 116 of the present disclosure may be the roof of a motorhome (as depicted in FIG. 2) or travel trailer (as depicted in FIG. 1). In embodiments in which the RV roof 116 is integrated within a travel trailer, the securement channel 162 discussed hereinabove may join a front wall of the RV 100 with the RV roof 116. In embodiments in which the RV roof 116 is integrated into a motorhome, a front end of the RV roof 116 may interface with a front cap of the RV 100. In such embodiments, the RV roof 116 may include a securement channel 162, or any other surface to interface with the front cap of the RV 100. As such, it should be understood that the securement channel 162 need not be included on all sides of the RV roof 116. The securement channel 162 may be included on any sides of the RV roof 116, such as only on the sides, rear, or front of the RV roof 116.

The securement channel 162 may be two-sided, such that the securement channel 162 is L-shaped. The joinery of the top edge portions 113 of the exterior wall 112 to the securement channel 162 of the RV roof 100 provides for a continuous surface along the side of the RV 100. As such, water and debris may be directed away from the securement channel 162 and top edge portion of the exterior wall 112; this provides for a durable and lasting connection between the exterior wall 112 and the RV roof 116.

The securement channel 162 may be formed within the biaxial glass perimeter 122 of the RV roof 116. In embodiments, the securement channel 162 may be formed within the interior facing shell 120A of the composite shell 120. Moreover, the securement channel 162 may run along the entire perimeter of the RV roof 116, such that all exterior walls 112 of the RV body 108 are secured within the securement channel 162. In embodiments, the securement channel 162 may run along only the longitudinal sides of the RV body 108, along only the axial sides of the RV body 108, or a combination thereof.

Referring again to FIG. 4, as noted hereinabove, the securement channel 162 may be L-shaped, such that the securement channel 162 includes a top surface 166 and a side surface 168. Adhesive may be applied to either or both of the top surface 166 or the side surface 168 of the securement channel 162 to secure the top edge portion 113 of the exterior wall 112 within the securement channel 162. In embodiments, the securement channel 162 may also be U-shaped, V-shaped, curved, or any other suitable shape.

A cross-sectional shape of the securement channel 162 of the RV roof 116 and a cross-sectional shape of the top-edge portion 113 of the exterior wall 112 of the RV body 108 may be complimentary. It is noted that these cross-sectional shapes are “complementary” in that they allow for a mechanically close fit when the top-edge portion(s) 113 of the exterior wall(s) 112 are inserted into the corresponding securement channels 162 of the RV roof 116 to provide a continuous wall/flush wall along the exterior side of the RV body 108. As such, the cross-sectional shape of the top-edge portion 113 of the exterior wall 112 and the cross-sectional shape of the securement channel 162 of the RV roof 116 may be of similar cross-sectional dimensions, but need not be exactly the same. In embodiments, the cross-sectional dimension of the top-edge portion 113 of the exterior wall 112 may be slightly smaller than those of the cross-sectional dimension of the securement channel 162 of the RV roof 116, such as to provide room for the adhesive along the top surface 166 or the side surface 168 of the securement channel 162.

In embodiments, the RV roof 116 may be sloped/curved. Referring to FIG. 4B, the side profile of the RV roof 116 may be tapered to increase aerodynamics. The RV roof 116 may include a front side 170, a rear side 172, and a center 174. The exterior facing shell 120B of the RV roof 116 may be tapered from the center 174 to the front side 170 and from the center 174 to the rear side 172. Such a taper increasing aerodynamics of the RV 100 and directs water/rain off of the RV roof 116. The exterior facing shell 120B of the RV roof 116 may also be tapered from the center 174 to any of the exterior walls 112 of the RV body 108. As depicted in FIG. 4A, the RV roof 116 may be tapered from the center 174 to the axial edges of the RV roof 116.

The RV roof 116 may also be longitudinally tapered at the front side 170 and the rear side 172. For example, referring to FIG. 3B, the front side 170 and the rear side 172 of the RV roof 116 may be tapered. Such a taper further increases aerodynamics of the RV 100, increasing fuel economy.

Referring again to FIG. 2, a top-view of the positioning of the RV battery 124, range extender 130, and electric motor 150 is depicted. As noted hereinabove, the RV battery 124 and range extender 130 are mounted between the longitudinal frame rails 104 of the chassis 102 and below the RV floor 114 of the RV body 108. The longitudinal frame rails 104 provide mounting surfaces for the RV battery 124 and range extender 130. Moreover, the positioning of the RV battery 124 and range extender 130 between the longitudinal frame rails 104 provides for protection of the RV battery 124 and range extender 130, as the longitudinal frame rails 104 block/absorb impacts.

Also depicted in FIG. 2 is the electric motor 150. The electric motor 150 may be a central e-drive motor, as depicted in FIG. 2. As such, the electric motor 150 may be mounted to the axle 106 to provide motive support to the axle 106. Although the electric motor 150 is depicted as being a central e-drive motor, it should be understood that embodiments of the present disclosure also include hub motors mounted at the wheels of the RV 100. There may also be more than one electric motor 150 integrated into the RV 100. The electric motor 150 is electrically coupled to the RV battery 124, such that the RV battery 124 provides power to the electric motor 150 to propel the RV 100. In embodiments, the RV battery 124 may also offboard power to electrical systems that are not included within the RV 100, such as to a home/building or another electric vehicle. The RV 100 may also automatically power a home in the case of a power outage.

The electric motor 150 is positioned rearward of the center of mass of the RV 100 (as explained further below). In this respect, the electric motor 150 is positioned rearward of the horizontal center of mass (e.g., the center of mass of the RV 100 along the X-axis of the cartesian coordinates of FIG. 2). The electric motor 150 rearward of the center of mass of the RV 100 provides for a center of mass near the center of the RV 100 and, thus, better handling/maneuverability of the RV 100.

The RV battery 124 is positioned forward of the center of mass of the RV 100 (e.g., forward of the center of mass of the RV 100 along the X-axis of the cartesian coordinates of FIG. 2). The RV battery 124 may include one, two, three, four, or more batteries. The RV battery 124 may be connected to various electronics of the RV 100 to provide power to the electronics. In embodiments, the RV battery is electrically coupled to lights, a 12V battery, RV appliances, the electric motor 150, the range extender 130, or any other power consuming device of the RV 100. The RV batteries 124 may be positioned proximal one another along the longitudinal length of the RV 100. In embodiments, the RV batteries 124 may also be positioned proximal one another along the axial length of the RV 100, or on top of one another along a height of the RV 100. The batteries 124 are also positioned below the RV floor 114. Positioning of the batteries 124 below the RV floor 114 provides for a lower center of mass with respect to the vertical center of mass of the RV 100 (e.g., the center of mass of the RV 100 along the Y-axis of the cartesian coordinates of FIG. 2). The lower center of mass of the RV 100 improves handling/maneuverability of the RV 100. The RV battery 124 may be a 400V or 800V architecture.

The range extender 130 is positioned rearward of the horizontal center of mass of the RV 100. The range extender 130 may be positioned within 5 feet, 10 feet, or 15 feet of the rear-end of the RV 100. The range extender 130 is electrically coupled to the RV battery 124. As such, the range extender 130 charges the RV battery 124, such as through the alternator 134. The range extender 130 may be capable of charging the RV battery 124 through level 1 charging, level 2 charging, or level 3 DC fast charging.

As noted hereinabove, the RV battery 124 and the range extender 130 are positioned below the RV floor 114 of the RV body 108. The RV battery 124 and the range extender 130 may also be positioned below a floor-facing surface 105 of the longitudinal frame rails 104, which further protects the RV battery 124 and the range extender 130 and further lowers the vertical center of mass of the RV 100 to improve handling/maneuverability of the RV 100. Moreover, the range extender 130 may be mounted rearward of the electric motor 150.

The range extender 130 includes the engine 132, the alternator 134, the fuel system 136, the cooling system 138, and the battery recharge controller 140. The engine 132 may be an internal combustion engine. In embodiments, the engine 132 may be a 4 cylinder engine, 6 cylinder engine, 8 cylinder engine, or any other suitable engine. The engine 132 receives fuel from the fuel system 136 to power the engine 132. The power from the engine 132 is then transferred to the RV battery 124, utilizing the alternator 134 to convert the mechanical power to electrical power to charge the RV battery 124.

The RV battery 124 may be charged through the engine 124, or through an EV charger. Embodiments of the present disclosure also include charging the RV battery 124 through the use of regenerative braking, further increasing fuel efficiencies of the RV 100.

The fuel system 136 may include a fuel tank, fuel lines, fuel pump, and any other components to provide fuel to the engine 132. The fuel system 136 may include a fuel tank of varying sizes. Moreover, the fuel tank may also be positioned below the RV floor 114, such as to further lower the vertical center of mass of the RV 100. The fuel tank may also be positioned between the longitudinal frame rails 104 or below the floor-facing surface 105 of the longitudinal frame rails 104. In embodiments the engine 132 may be positioned rearward of the horizontal center of mass, while other components of the range extender 130 such as the fuel system 136 are positioned forward of the horizontal center of mass. The fuel tank may be have a capacity of 50 gallons or more.

The cooling system 138 includes components such as but not limited to a radiator, pump, thermostat, cooling lines/hoses, and coolant. The cooling system 138 circulates coolant throughout the engine 132 to cool the engine 132.

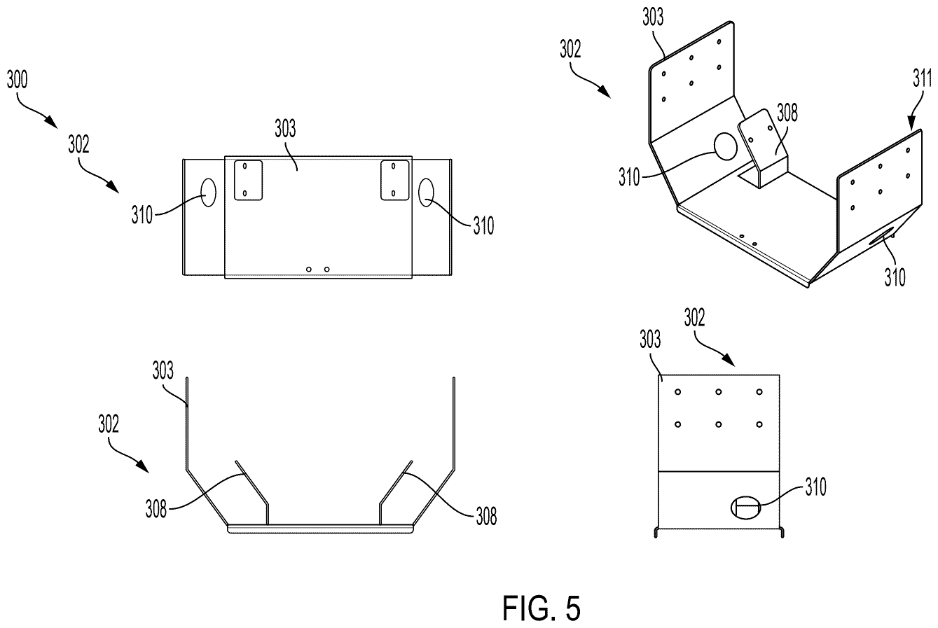

Referring to FIGS. 5-8, mounting brackets 300 for the range extender 130 are depicted. Specifically, with reference to FIG. 5, a bottom, front, side, and isometric views of an engine bracket 302 used to mount the engine 132 to the RV 100 are depicted. The engine bracket 302 may include raised flanges 308. The raised flanges 308 may support the engine 132 of the range extender 130. The raised flanges 308 also dampen vibrations transferred to the engine 132 from the chassis 102 of the RV 100, preventing engine 132 movement and reducing damage of engine components.

The engine bracket 302 may further include an engine mount frame 303. The engine mount frame 303 may include cavities 310. The cavities 310 may permit connections to the engine 132 through the engine bracket 302, such as cooling and electrical lines. Moreover, the cavities 310 may distribute stresses that act on the engine bracket 302. The cavities 310 may further allow for repair of the engine 132 without dismounting the engine 132 from the engine bracket 302; components of the engine 132 may be reached through the cavities 310. Although two cavities 310 are depicted on each side of the engine bracket 302, it should be understood that any number of cavities 310 may be included anywhere on the engine bracket 302, such as on a bottom surface 303 of the engine bracket 302.

The engine bracket 302 may further include connection points 311 that allow for the engine bracket 302 to be mounted to corresponding connection points of the longitudinal frame rails 104 of the chassis 102. In embodiments, the engine bracket 302 may be mounted to the longitudinal frame rails 104 of the chassis 102. The engine bracket 302 may be coupled to the chassis 102 through the use of bolts, screws, welding, or any other suitable means of coupling.

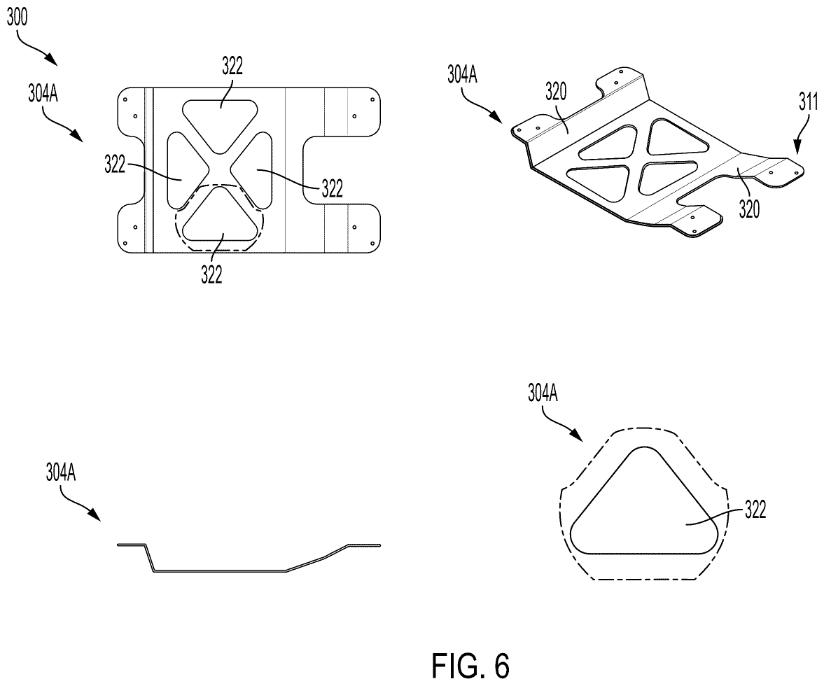

Referring now to FIG. 6, a fuel tank bracket 304 is depicted. Specifically, a bottom fuel tank bracket 304A is depicted. The bottom fuel tank bracket 304A may include connection points 311 that allow for the bottom fuel tank bracket 304A to be mounted to corresponding connection points on the bottom of the longitudinal frame rails 104 of the chassis 102. In embodiments, the fuel tank bracket 304 may be mounted to the longitudinal frame rails 104 of the chassis 102. The fuel tank bracket 304 may be coupled to the chassis 102 through the use of bolts, screws, welding, or any other suitable means of coupling.

The bottom fuel tank bracket 304A may include a sloped surface 320 that further secures a fuel tank of the range extender 130 therein. The bottom fuel tank bracket 304A includes cutouts 322 that may reduce weight and distribute stresses throughout the fuel tank bracket 304. The cutouts 322 may be triangular, circular, ovular, or any other suitable shape. The bottom fuel tank bracket 304A may be coupled to a top fuel tank bracket 304B to further secure the fuel tank within the fuel tank bracket 304.

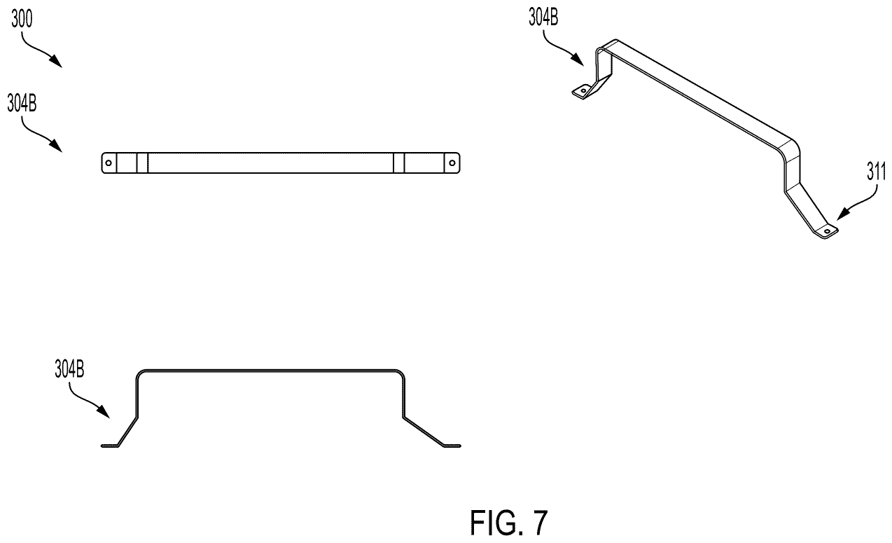

Referring now to FIG. 7, the top fuel tank bracket 304B is depicted. The top fuel tank bracket 304B may include connection points 311 that connect the top fuel tank bracket 304B to the bottom fuel tank bracket 304A or corresponding connection points of the longitudinal frame rails 104 of the chassis 102.

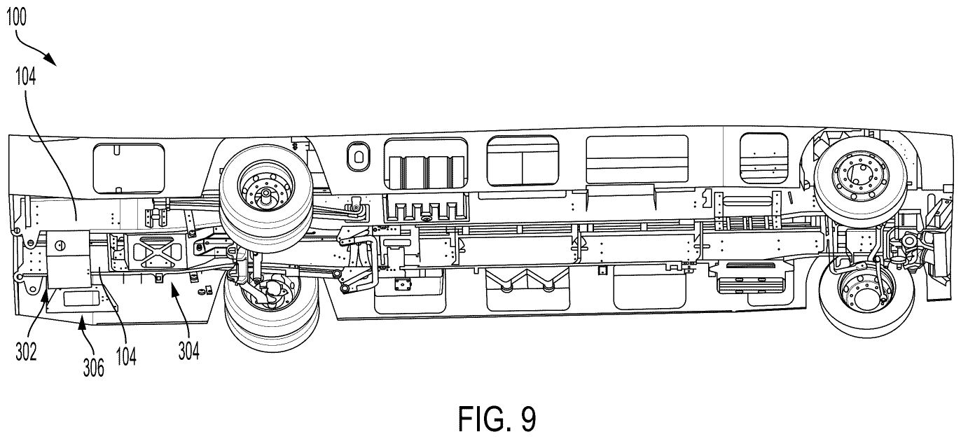

FIG. 9 depicts the engine bracket 302 and the fuel tank bracket 304 mounted to the chassis 102. Specifically, the engine bracket 302 and the fuel tank bracket 304 are mounted between the longitudinal frame rails 104 of the chassis 102.

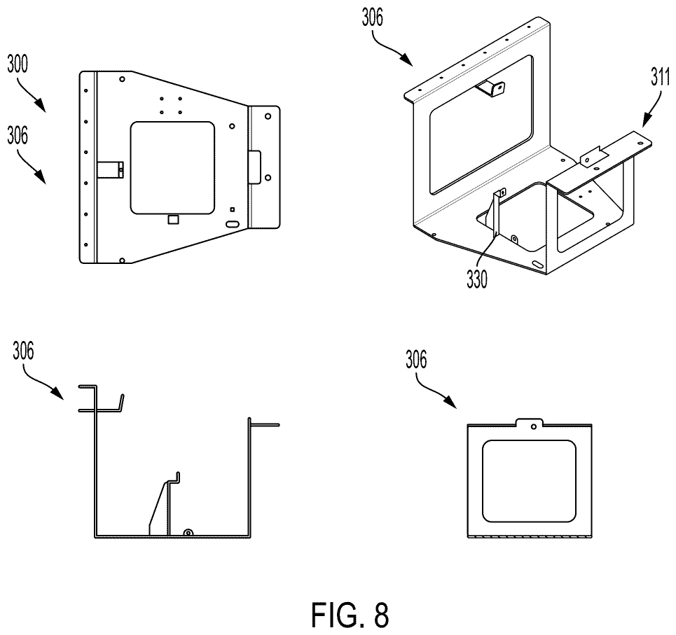

A radiator bracket 306 is depicted in FIG. 8. Specifically, the radiator bracket 306 may mount a radiator of the cooling system 138 of the range extender 130 to the longitudinal frame rails 104 of the chassis 102. The radiator bracket 306 may include a gusset 330. The gusset 330 may mount the radiator to the radiator bracket 306 and stabilize the radiator during transit of the RV 100. Although one gusset 330 is depicted in FIG. 8, it should be understood that any number of gussets 330 may be included on the radiator bracket 306. In embodiments, the radiator bracket 306 may include connection points 311 that may correspond to connection points of the longitudinal frame rails 104 of the chassis 102. In embodiments, the radiator bracket 306 may be mounted to the longitudinal frame rails 104 of the chassis 102. The radiator bracket 306 may be coupled to the chassis 102 through the use of bolts, screws, welding, or any other suitable means of coupling.

Although the aforementioned brackets are referenced as being coupled to the longitudinal frame rails 104 of the chassis 102, it should be understood that embodiments of the present disclosure include such brackets mounted anywhere on the chassis 102 of the RV 100.

Embodiments of the present disclosure allow for range extension of the RV 100. As such, the battery recharge controller 140 of the range extender 130 may include logic as to when the range extender 130 is to turn on the engine 132 to supply energy to the RV batter(ies) 124. The range extender 130 may supply energy to the RV batteries 124 when one or more of the RV batteries 124 have are below a threshold state of charge (SOC). The engine 132 may quickly charge the RV battery 124, such as through 800V fast charging, as the range extender 130 may be integrated into an 800V architecture, as noted hereinabove. The engine 132 may also charge the RV batteries 124 through Level 1, Level 2, Level 3 fast charging, or any other suitable charging voltage. As such, the RV batteries 124 may be 800V batteries, or any other suitable voltage. The range extender 130 described herein may be integrated into any Class of RV or RV trailer, including class 5, 6, and 7 RVs, or Class A, B, or C body style of motorhomes. The range extender 130 may also be utilized in travel trailers, as noted hereinabove.

Various components may be mounted to and run along the longitudinal frame rails 104 of the chassis 102, such as cooling systems, cooling lines, mounts for water/waste containers, leveling jacks, drivetrain components, batteries, or other components. As noted herein, the range extender 130 of the present disclosure may be integrated into an 800V architecture. As such, smaller/lighter wires may be utilized in the 800V architecture compared to lower voltage architectures, as less current is required in the 800V architecture. Smaller wires of the 800V architecture allows for more space for other components to be mounted to the chassis and an overall lighter RV 100. Moreover, the increased space from the smaller wires allows mounting space for any additional components of the 800V architecture. The smaller wires may also allow for larger/additional batteries and cooling components to be mounted to the chassis 102. The smaller wires also reduce costs, as less copper wiring is required in the 800V architecture. The 800V architecture may also include additional hardware that allows the RV batteries 124 to be charged by lower voltage chargers. Space for such additional hardware may be made available through the smaller wires discussed herein.

Embodiments of the present disclosure also provide for advantageous mounting/positioning of the range extender 130. The range extender 130 may be placed within the longitudinal frame rails 104 of the chassis 102. Moreover, the range extender mount 300 provides for dampening of vibrations acting on the range extender 130 and its various components.

As noted hereinabove, the mounting of the range extender 130, the battery 124, and the electric motor 150 below the RV floor 114 provide for a lowered vertical center of mass of the RV 100. The lightweight RV roof 116 further provides a lowered vertical center of mass of the RV 100. The vertical center of mass of the RV 100 may be from 6 inches to 18 inches above the floor-facing surface 105 of the longitudinal frame rails 104. Moreover, mounting of the range extender 130 and electric motor 150 rearward of the longitudinal center of mass of the RV 100, and mounting of the battery 124 forward of the longitudinal center of mass of the RV 100 provides for a longitudinal center of mass of the RV 100 near the center of the RV 100. Such a lowered and more central center of mass provides for improved handling of the RV 100, and a decreased risk of rollover of the RV 100.

Collectively, the various features of the RV power system described herein provide a an RV with a range extender. The mounting positions of the range extender, batteries, and electric motor provide for an RV with improved handling. Moreover, the RV roof described herein provides for a lower center of mass and increased aerodynamics, increasing fuel efficiency.

For the purposes of describing and defining the present invention it is noted that terms like “near” are utilized herein to represent the inherent degree of uncertainty that may be attributed to any quantitative comparison, value, measurement, or other representation. The term “near” is also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A recreational vehicle (RV) comprising:
a chassis comprising longitudinal frame rails;
an axle;
an RV body enclosing a living area supported by the chassis, wherein the RV body comprises an exterior wall, an RV floor, and an RV roof, the RV roof comprising:
a plurality of foam core units;
a composite shell surrounding a majority of the plurality of foam core units; and
a biaxial glass perimeter along a perimeter of the RV roof;
an RV battery coupled to the chassis and positioned:
between the longitudinal frame rails;
forward of a center of mass of the RV; and
below the RV floor of the RV body;
a range extender comprising an engine, an alternator electrically coupled to the RV battery, a fuel system, a cooling system, and a battery recharge controller, wherein the range extender is coupled to the chassis and positioned:
between the longitudinal frame rails;
rearward of the center of mass of the RV; and
below the RV floor of the RV body; and
an electric motor electrically coupled to the RV battery, wherein the electric motor provides motive support to the axle of the RV and the electric motor is positioned rearward of the center of mass of the RV.

2. The RV of claim 1, wherein the center of mass of the RV is from 6 inches to 18 inches above a floor-facing surface of the longitudinal frame rails.

3. The RV of claim 1, wherein:
the RV roof comprises a securement channel on the interior side of the RV roof;
the exterior wall comprises a top-edge portion; and
the top-edge portion of the exterior wall fits within the securement channel of the RV roof.

4. The RV of claim 3, wherein the securement channel of the RV roof runs along the perimeter of the RV roof.

5. The RV of claim 3, wherein the top-edge portion of the exterior wall of the RV body is secured within the securement channel of the RV roof through adhesive.

6. The RV of claim 3, wherein the securement channel is positioned within the composite shell of the RV roof.

7. The RV of claim 1, wherein the plurality of foam core units comprise a fiberglass reinforcement layer.

8. The RV of claim 1, wherein the exterior side of the RV roof comprises a center, a front side, and a rear side, wherein an exterior facing side of the RV roof is tapered from the center to the front side and from the center to the rear side.

9. The RV of claim 1, wherein the interior side of the RV roof comprises accessory channels.

10. The RV of claim 1, wherein a unit of the plurality of units includes a skylight cutout.

11. The RV of claim 1, wherein the range extender charges the RV battery through Level 3 DC fast charging.

12. The RV of claim 1, wherein the engine of the range extender is coupled to the chassis via an engine mount, the engine mount comprising:
raised flanges that support the engine; and
an engine mount frame comprising cavities to permit connections to the engine through the cavities of the engine mount frame.

13. The RV of claim 12, wherein the generator mount dampens vibrations transferred to the generator.

14. The RV of claim 1, wherein the range extender is mounted below the floor-facing surface of the longitudinal frame rails.

15. The RV of claim 1, wherein the range extender is mounted rearward of the electric motor.

16. The RV of claim 1, further comprising a plurality of batteries arranged along a length of the RV.

17. A recreational vehicle (RV) comprising:
a chassis comprising longitudinal frame rails;
an axle;
an RV body enclosing a living area supported by the chassis, wherein the RV body comprises an exterior wall, an RV floor, and an RV roof, the RV roof comprising:
a plurality of foam core units;
a composite shell surrounding a majority of the plurality of foam core units; and
a biaxial glass perimeter along a perimeter of the RV roof;
an RV battery coupled to the chassis and positioned:
between the longitudinal frame rails; and
below the RV floor of the RV body;
a range extender comprising an engine, an alternator electrically coupled to the RV battery, a fuel system, a cooling system, and a battery recharge controller, wherein the range extender is coupled to the chassis and positioned:
between the longitudinal frame rails; and
below the RV floor of the RV body, wherein the range extender and RV battery are positioned on opposite longitudinal sides of a center of mass of the RV; and
an electric motor electrically coupled to the RV battery, wherein the electric motor provides motive support to the axle of the RV.

18. The RV of claim 17, wherein the electric motor and RV battery are positioned on opposite longitudinal sides of a center of mass of the RV.

19. The RV of claim 17, wherein the center of mass of the RV is from 6 inches to 18 inches above a floor-facing surface of the longitudinal frame rails.

20. The RV of claim 17, wherein:
the RV roof comprises a securement channel on the interior side of the RV roof;
the exterior wall comprises a top-edge portion; and
the top-edge portion of the exterior wall fits within the securement channel of the RV roof.
